(19) United States
(12) Patent Application Publication
(10) Pub. No.: US 2021/0227870 A1
(43) Pub. Date: Jul. 29, 2021

(54) ECO-FRIENDLY HORIZONTAL-AXIS HYDROWASHER FOR FERMENTED COFFEE

(71) Applicants: Alvaro Ardila Duarte, Santander (CO); PENAGOS HERMANOS Y CIA S.A.S., Santander (CO)

(72) Inventors: Alvaro ARDILA DUARTE, Santander (CO); Elias ARIZA VILLAMIL, Santander (CO)

(73) Assignee: Penagos Hermanos Y CIA S.A.S., Santander (CO)

(21) Appl. No.: 17/051,219

(22) PCT Filed: May 15, 2019
(86) PCT No.: PCT/IB2019/054047

§ 371 Date: Oct. 28, 2020

(30) Foreign Application Priority Data
May 18, 2018 (CO) NC2018/0005205

(51) Int. Cl. A23N 12/02; A23F 5/02; B08B 1/00; B08B 1/04; B08B 3/02; B08B 9/032; B02B 3/12; B02B 3/08

(52) U.S. Cl. CPC A23N 12/02; A23F 5/02; B08B 1/005; B08B 1/04; B08B 2209/032; B08B 9/0321; B02B 3/12; B02B 3/08; B08B 3/024

(57) ABSTRACT

The invention relates to a horizontal axis pressure washer that allows removing the mucilage from fermented coffee efficiently with a low consumption of water and power. The main characteristic of the pressure washer of the present invention is the rotor located horizontally in a circular basket, where said rotor comprises several rows with three types of fingers specialized in three tasks: cleaning, shaking and injecting water with pressure. Said combination of functionalities allows the complete elimination of mucilage from fermented coffee.

### TECHNICAL FIELD

The present invention belongs to the field of mechanics and consists of a horizontal axis pressure washer, which particularly allows the removal of mucilage from fermented coffee. Said washer allows obtaining a mucilage-free coffee bean thanks to the novel system of three specialized fingers located in rows on a horizontal rotor and a horizontal circular basket containing said rotor.

### TECHNICAL BACKGROUND OF THE INVENTION

Coffee cherries are the raw fruit of the coffee plant, which is made up of two coffee beans covered in a thin parchment, as a hull surrounded by pulp. The transformation process of the coffee cherry into the final product for commercialization is known as “the coffee benefit” and basically comprises the following steps: 1) selective or non-selective coffee harvesting, 2) classification of cherry coffee, 3) depulping, 4) demucilaging or washing and 5) drying.

The demucilagination stage is the process to eliminate the mucilage that covers the endocarp or parchment of the bean that is exposed after carrying out the depulping process. Said demucilagination can be carried out by various techniques, among which are the chemical demucilagination process, where products such as sodium, potassium or calcium hydroxide are applied to the depulped coffee stacks to trigger an alkaline hydrolysis. However, coffee subjected to this chemical process is characterized by being less acidic.

Alternatively, the demucilagination can be done by mechanical means, where the use of demucilagination machines is required, such as that described in document US20120328751, which performs said process mechanically. However, these types of processes, which do not include the microbial fermentation stage, can result in physicochemical and sensory modifications in the coffee.

On the other hand, in the state of the prior art, machines that carry out the depulping, fermentation and washing processes within a machine that mechanically transports the coffee between compartments for each of said processes are also known. For example, the machine described in document WO2013114341 allows the fruits to be washed after their fermentation. Said washing is carried out in a washer that consists of a rotor, which has stirrers and spacers, the latter separate the stirrers that are rotationally connected to a square cross-section steel shaft, in addition said shaft is connected in its upper part to a motor. As a particular characteristic, within the stirrers described above there are ones with a longer vane called a cleanser, which has the same cross section as the stirrers, allowing the interior surface of the basket that contains the entire system to be kept clean.

Among the machines described in the state of the prior art for the integral treatment of coffee (depulping, demucilagination, drying) document U.S. Pat. No. 2,261,560A is found. In said document, in order to depulp the bean, the use of water injected under pressure along a tube that conveys the beans is described. Additionally, the post-depulping washing stage is carried out in a rotating metal basket.

Finally, it is pertinent to highlight that demucilagination can be carried out through fermentation processes that are based on solubilization of the mucilage due to the decomposition of pectins, a process that occurs during the fermentation of the ripe fruit.

However, the traditional processes of demucilagination by fermentation of the depulped bean imply high costs at an ecological level, because the post-fermentation washing stage requires the use of large quantities of water to wash the beans and eliminate the residual mucilage from the fermentation. For example, in the vast majority of mills this washing is carried out by manually stirring the beans with paddles in a washing tank. In this process, extensive use of water is necessary, approximately 25 to 30 m³ of water per metric ton of processed coffee.

Alternatively, mechanical washers are known, which can have a horizontal or vertical axis, which are characterized by comprising a cylinder within which a central axis rotates provided with blades to ensure the stirring and advancement of the coffee mass (see Coffee Technology Volume 2. R. J Clarke and R. Macrae. Elseivier Science Publishers LTD. 1987. ISBN 13-978-94-010-8028-6 Page 19).

In this sense, the fermented coffee washing machine, MEGAWASHER, is widely known in the market. This machine has a vertical axis in which the fermented coffee enters the lower area of the equipment and is driven by an endless conveyor, then a rotor with fingers drives the coffee, printing the necessary rotation speed to create the centrifugal force that separates the mucilage attached to the beans that comes out of the grooves of the basket.

Within the state of the prior art there is also the washing machine described in patent U.S. Pat. No. 1,796,856, where the beans are immersed in water and transported in a direction with a steep upward inclination, in such a way that said beans rise slowly while the water travels in the opposite direction, until it is discharged at a lower level together with the residue carried in said wash water.

From all the foregoing, it is clear that the need for machines that allow the washing of fermented coffee in order to eliminate mucilage and that reduce the amount of water and power required in the process persists in the state of the prior art.

### GENERAL DESCRIPTION OF THE INVENTION

The present invention relates to a washing machine useful for removing mucilage attached to coffee beans after they have been subjected to the fermentation process.

Said washer has as its main characteristic the efficient use of washing water, due to the unique configuration of a circular basket and a rotor comprising specialized fingers located along it.

In this way, the coffee enters the hopper and is transported along the circular basket thanks to the movement of the rotor. During this transport, the fermented coffee beans are stirred by metal stirrer fingers fixed to the rotor. Additionally, the fermented coffee beans are subjected to jets of water under pressure ejected by finger injectors. At the same time, cleaning fingers, which are moving parts attached to the rotor, perform a cleaning of the circular basket by efficiently removing mucilage and impurities.

In this way, the joint action of the three types of fingers mounted on the horizontal rotor ensure the complete elimination of the mucilage adhered to the coffee beans, which were previously fermented, with a low consumption of water and power.

### DESCRIPTION OF THE FIGURES

FIG. 1 shows a flow diagram in which the passage of the fermented coffee through the horizontal axis pressure washer and its interaction with each of its parts is illustrated.

FIG. 2 shows the exploded view of the horizontal axis pressure washer of the invention.

FIG. 3 corresponds to an additional exploded view of the circular basket (2), the rotor (3) and the fingers attached to it (3A), (3B) and (3C).

FIGS. 4A and 4B are schematic perspective views of the horizontal axis pressure washer of the assembled invention.

### DESCRIPTION OF THE ELEMENTS THAT FORM THE HORIZONTAL AXIS PRESSURE WASHER FOR FERMENTED COFFEE OF THE INVENTION

(1) Chassis: corresponds to a metallic structure to which, by means of screws, the circular basket (2), the electric motor (23), the electric pump (14), the guards (28), (29), (30) and (31), and the trolley (32); The latter supports the entire horizontal axis pressure washer and facilitates its movement.
(2) Circular basket: corresponds to a structure built with square, round, or perforated sheet rods. The circular basket (2) is tied to the chassis (1) by screws and at its ends, the inlet frame (4) and the outlet frame (5) are hold with screws.
(3) Rotor: corresponds to a metal tube with helix-welded plates, forming two augers, one inlet and one outlet. The rotor (3) also has welded metal fingers called: (3A), (3B) and (3C), which form circles around the rotor. Finally, the rotor (3) has two shaft tips welded at its ends and is mounted on the rolls of the bearings (7).
   (3A) Stirring finger: these are metal fingers welded to the rotor (3) that serve to stir and rub the fermented coffee beans, so that the mucilage adhering to them is released after the fermentation process
   (3B) Injector finger: they are perforated metal fingers, which are welded to the rotor (3) and allow the passage of water into the chamber formed by the rotor tube (3) and the circular basket (2). Thanks to its design, it is possible to inject and atomize the water coming from the electric pump (14), achieving an efficient use of water.
   (3C) Cleaning finger: corresponds to a set of three pieces, two metallic and one plastic. The first metal piece acts as a base and is welded to the rotor. The second metal part is mounted on the first metal part and carries the plastic part. The second metal part and the plastic part move as a consequence of the centrifugal force generated by the rotation of the rotor (3), so that the plastic part rubs with the internal part of the circular basket (2). Said friction manages to keep the circular basket (2) clean, allowing the evacuation of mucilage and impurities efficiently.
(4) Inlet frame: corresponds to a cast metal part that is fastened with screws to the circular basket (2). Besides the inlet frame (4), the following are secured by means of screws: the hopper (8) and the flange (6).
(5) Outlet frame: corresponds to a cast metal part that is attached with screws to the circular basket (2). Besides the outlet frame (5), the following are secured by means of screws: the outlet mouth (9) and the flange (6).
(6) Flanges: correspond to two metal pieces that are secured with screws to the inlet and outlet frames (4) and (5), which also carry the bearings (7).
(7) Bearings: correspond to two metal pieces with rolls that are secured with screws to the flanges (6). The rotor (3) is mounted on the rolls of these bearings.
(8) Hopper: corresponds to a metal or plastic piece that stores the fermented coffee to be washed.
(9) Outlet mouth: corresponds to a metal or plastic piece that guides the washed coffee beans when they leave the horizontal axis pressure washer.
(10) Seal holder: corresponds to a mechanical device used to regulate and allow the passage of water to the rotor (3) through a mechanical seal, it is used to work between a fixed and a moving part.
(11) Mucilage tank: corresponds to a metal or plastic container that receives the mucilage and water removed during the process
(12) Mucilage tank lid: corresponds to a sheet or plastic cover.
(13) Lid complement: corresponds to a sheet or plastic cover.
(14) Electric pump: corresponds to a high pressure, low flow, self-priming electric motor pump that supplies clean water under pressure to the parts where it is required within the horizontal axis pressure washer.
(15) Foot valve: corresponds to a metallic or plastic device installed at the end of the suction hose (16), which prevents the discharge of the electric pump (14), and at the same time filters the water used in the process.
(16) Suction hose: corresponds to a plastic rubber duct, which leads the clean water to the electric pump (14).
(17) Tee: corresponds to a metallic or plastic accessory that allows interconnecting the suction of the electric pump (14) with the distributor (19), to achieve a bypass, necessary to balance the operation of the electric pump (14).
(18) Elbow: corresponds to a metallic or plastic accessory that allows connecting the discharge of the electric pump (14) with the distributor (19).
(19) Distributor: corresponds to a metal tube to which the hoses (22) are connected.
(20) Reducer socket: corresponds to a metal or plastic accessory that is connected to the distributor (19) and allows the passage of water to the rotor (3) through the seal holder (10).
(21) Valves: correspond to metal or plastic accessories that are used to regulate the passage of water to the hopper (8) and to the outlet frame (5).
(22) Hoses: correspond to plastic, rubber or synthetic ducts that lead the water to the different parts of the horizontal axis pressure washer.
(23) Electric motor.
(24) Motor base: corresponds to a metallic accessory that secures and supports the electric motor (23).
(25) Pulley: corresponds to a metal piece that is mounted on the electric motor shaft (23) and transmits the movement through the belts (26) to the flywheel (27) and this in turn is mounted on the rotor (3).
(26) Belts: correspond to synthetic belts that transmit the movement of the pulley (25) to the flywheel (27).
(27) Flywheel: corresponds to a metal piece that is mounted on one of the rotor tips (3) and transfers the movement to it.
(28) Engine guard: corresponds to a metal or plastic cover that protects the engine and serves to prevent accidents.
(29) Right side guard: corresponds to a metal or plastic cover, which prevents access to moving parts, avoiding accidents.
(30) Rear guard: corresponds to a metal or plastic cover, which prevents access to moving parts, avoiding accidents.
(31) Left side guard: corresponds to a metal or plastic cover, which prevents access to moving parts, avoiding accidents.
(32) Trolley: Corresponds to a metallic structure with wheels, on which the horizontal axis pressure washer is secured with screws to facilitate the movement of the machine.

### DETAILED DESCRIPTION

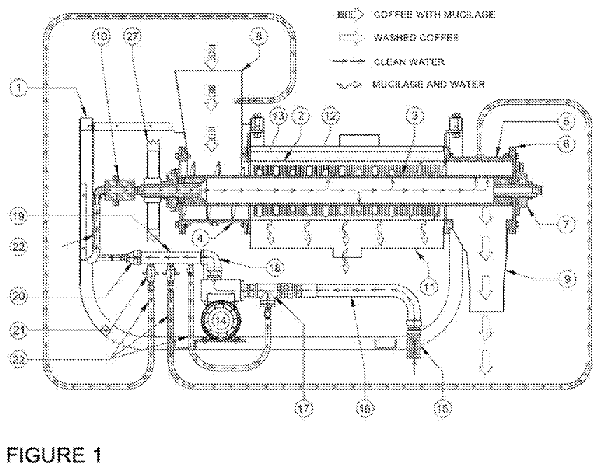

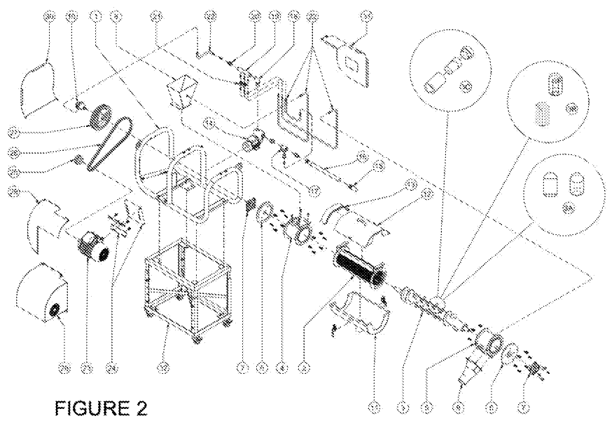

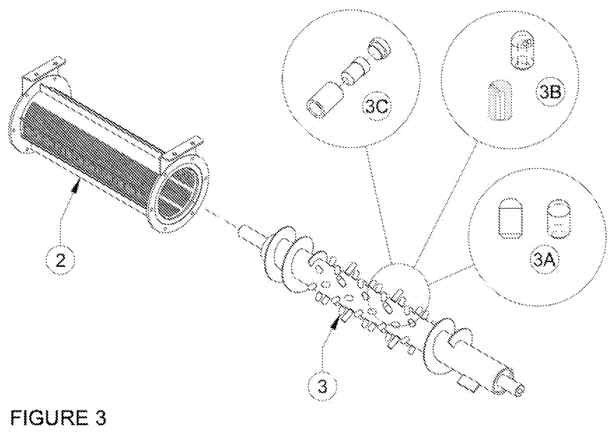

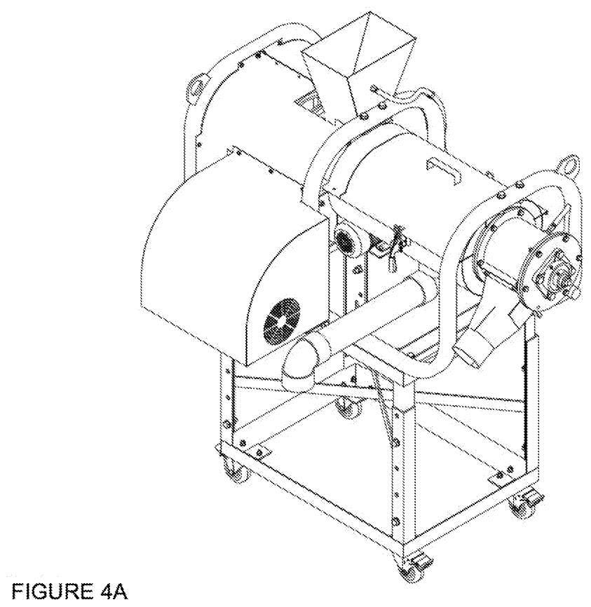

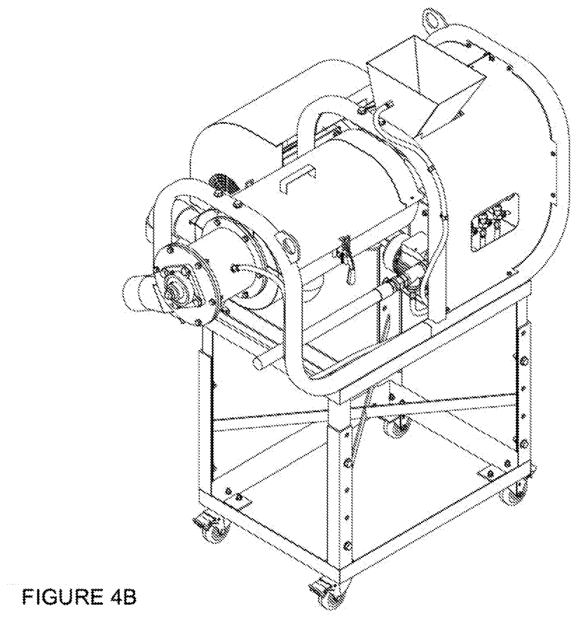

According to FIG. 1, the fermented coffee covered with mucilage enters the hopper (8) together with a flow of water from the electric pump (14), and is received by the inlet frame (4), which is tied by screws to the basket (2), to the hopper (8) and to the flange (6). The rotor inlet auger (3), located horizontally, has the function of dosing the fermented coffee that enters the circular basket (2) placed horizontally.

Inside the circular basket (2) the fermented coffee comes into direct contact with the metal fingers (3A), (3B) and (3C), which are welded to the central body of the rotor (3). Each finger has a particular role in the process of removing mucilage from fermented coffee:

Stirring finger (3A): these are metal fingers welded to the rotor (3) that serve to stir and rub the fermented coffee beans, in such a way that the mucilage adhering to them is released after the fermentation process.

Injector finger (3B): they are perforated metal fingers, welded to the rotor (3) that allow the passage of water into the chamber formed by the rotor tube (3) and the circular basket (2). Thanks to its design, it is possible to inject and atomize the water coming from the electric pump (14), coming into contact with the fermented coffee beans. This action achieves an efficient use of water.

Cleaning finger (3C): corresponds to a set of three pieces, two metallic and one plastic. The first metal piece acts as a base and is welded to the rotor. The second metal part is mounted on the first metal part and carries the plastic part. The second metal part and the plastic part move as a consequence of the centrifugal force generated by the rotation of the rotor (3), so that the plastic part rubs with the internal part of the circular basket (2). Said rubbing manages to keep the circular basket (2) clean, allowing the evacuation of mucilage and impurities efficiently.

The fingers (3A), (3B) and (3C) are mounted on the rotor (3), and are distributed in rows around it, where each row has the three types of fingers.

The fingers (3A), (3B) and (3C) that are mounted on the rotor (3), rotate with it, work simultaneously as a team, so that: (3A) agitates and rubs the beans, (3B) injects and atomizes the water at high pressure, and (3C) cleans the internal part of the circular basket (2), thus achieving a very low water consumption and a very good washing of the fermented coffee beans.

Now, the mucilage and contaminants removed from the fermented coffee beans by the action of the rotor (3), the stirring fingers (3A) and the pressurized water injected by the fingers (3B), are ejected from the system by the action of the cleaning fingers (3C) through the circular basket (2). This is possible thanks to the structure of the circular basket (2) that is made of square, round, or perforated sheet rods. In this way, the mucilage and contaminants are stored in the mucilage tank (11), which is a metal or plastic container, which receives the mucilage and water eliminated during the process.

Once the mucilage is effectively removed from the fermented coffee beans, it moves to the outlet frame (5) which is screwed to one end of the circular basket (2), to the outlet mouth (9) and to the flange (6). With the help of the rotor outlet auger (3) and water from the electric pump (14), the washed coffee is expelled from the horizontal axis pressure washer through the outlet mouth (9) which is inclined. Alternatively, the washed coffee can be expelled without water from the electric pump (14), as long as the outlet frame (5) and the outlet mouth (9) are disposed downward.

Now, for the correct operation of the horizontal axis pressure washer of the invention, an efficient clean water distribution system is required. Said system is composed of the electric pump (14) which corresponds to a high pressure and low flow self-priming electric motor pump, a distributor (19) and additional elements as described below.

The electric pump (14) is fed by the suction hose (16) that corresponds to a plastic or rubber duct that comprises at its end a foot valve (15), where said foot valve (15) corresponds to a metallic or plastic device that prevents the electric pump (14) from discharging and at the same time filters the water used in the process.

As shown in FIG. 1, the water driven by the electric pump is conducted through an elbow (18) to a distributor (19) which has four outlets connected to hoses (22).

The first outlet of the distributor (19) comprises a reducer socket (20), which is a metal or plastic accessory that is connected to the distributor (19) allowing the passage of water to the rotor (3) through the seal holder (10), the latter in turn is a mechanical device used to regulate and allow the passage from the water to the rotor (3) through a mechanical seal. Once the clean water has entered the rotor (3) it is injected under pressure into the circular basket (2) by means of the injector fingers (3B). The second outlet of the distributor (19) leads the clean water to the inlet hopper (8), and the third outlet leads the clean water to the outlet frame (5), said two outlets are regulated by valves (21). Finally, the fourth outlet leads the clean water to a tee (17) that corresponds to a metal or plastic accessory that allows interconnecting the suction of the electric pump (14) with the distributor (19), to achieve a bypass, necessary to balance the operation of the electric pump (14).

Additionally, for the correct operation of the horizontal axis pressure washer of the invention, a mechanical system is required that allows control of the movement of the rotor (3). Said system is composed of a motor (23) located on a base (24), which secures and supports it, a pulley that is a metallic piece that is mounted on the shaft of the electric motor (23) and transfers the movement through the belts (26) to the flywheel (27), this in turn is mounted on the rotor (3) that has two shaft ends welded at its ends and is mounted on the rolls of the bearings (7), which are secured with screws to the flanges (6), which in turn correspond to two metal pieces that are secured with screws to the inlet (4) and outlet (5) frames.

Finally, the systems described above are supported by a chassis that is a metallic structure, which is secured by screws: the circular basket (2), the electric motor (23), the electric pump (14), the guards (28), (29), (30) and (31) and the trolley (32); The latter supports the entire horizontal axis pressure washer and facilitates its movement.

Other structures necessary for the protection of the horizontal axis pressure washer and the user are: the mucilage tank lid (11), the lid complement (13), the motor guard (28), the rear guards (30), right side (28) and left side (31) guards. Finally, the horizontal axis pressure washer is secured with screws to a metal trolley (32) to facilitate the movement of the machine.

### EXAMPLE

In order to highlight the operation and advantages of the horizontal axis pressure washer disclosed in the present invention, below is a comparison of the average consumption of water and power as a function of the amount of fermented coffee processed using a manual washing, the known MEGAWASHER and the horizontal axis pressure washer disclosed in the present invention.

| | | Motor | Water | Mechanical |
|---|---|---|---|---|
| Process | Capacity | Power | Consumption* | Damage |
| Manual | — | — | 25 to 30 m³ of | No damage |
| Washing | | | water per metric | |
| | | | ton of processed | |
| | | | coffee | |
| MEGAWASHER | 3000 to 3500 | 5 H.P | 17 Liters/ | Less than |
| | Kg of coffee | | minute | 0.5% |
| | per hour | | | |
| ECOMILL | 5000 Kg of | Greater | 16 Liters/ | Less than |
| | coffee per | than | minute | 0.4% |
| | hour | 5 H.P | | |
| Horizontal axis | 6000 to 7000 | 3 H.P | 12 Liters/ | Less than |
| pressure washer | Kg of coffee | | minute | 0.1% |
| (invention) | per hour | | | |

*The water used in the transport is not included.

From the above, it is possible to affirm that the horizontal axis pressure washer for fermented coffee disclosed in the present invention allows to radically reduce the use of water and the power required for the removal of mucilage.

For example, according to the previous table and carrying out the conversions of the case, the manual washing process consumes 1 L of water for every 0.04 Kg of washed coffee, the MEGAWASHER is capable of washing 2.9 Kg of coffee for every liter of water, ECOM ILL is capable of washing 5.5 kg of coffee per liter of water, and surprisingly, the horizontal axis pressure washer of the invention processes 8.5 kg of coffee per liter of water.

Finally, it is also clear from the above table that the horizontal axis pressure washer for fermented coffee of the invention reduces the mechanical damage of washed coffee compared to the systems known in the prior art.

The efficiency achieved by the horizontal axis pressure washer disclosed in the present invention corresponds, in fact, to a considerable improvement compared to what is known in the state of the prior art, given the efficient use of water, thus becoming a practical and efficient alternative to reduce the costs and ecological impact of processing fermented coffee.

1. Pressure washer for fermented coffee comprising a hopper (8), an inlet frame (4), a circular basket (2), a horizontal rotor (3), which in turn comprises specialized fingers located along it, wherein the fingers are characterized by being i) metal stirring fingers (3A) fixed to the rotor, ii) pressurized water injectors fingers (3B) and iii) cleaning fingers (3C), an outlet frame (5) and an outlet mouth (9).

2. The pressure washer of claim 1, wherein the stirring fingers are metal fingers welded to the rotor (3) and agitate and rub the fermented coffee beans to loosen the mucilage adhered to the fermented coffee beans.

3. The pressure washer of claims 1 and 2, wherein the injector fingers are perforated metal fingers, which are welded to the rotor (3) and allow the passage of water into the chamber formed by the rotor tube (3) and the circular basket (2).

4. The pressure washer of claims 1 to 3, wherein the cleaning fingers are made up of a set of three pieces, two metal and one plastic, wherein the first metal piece acts as a base and is welded to the rotor, the second metal piece is mounted on the first metal part and carries the plastic part, and the second metal part and the plastic part move as a consequence of the centrifugal force generated by the rotation of the rotor (3), so that the plastic part rubs with the internal part of the circular basket (2), where said rubbing manages to keep the circular basket (2) clean, allowing the evacuation of mucilage and impurities in an efficient manner.

5. The pressure washer of claims 1 to 4, wherein the fingers (3A), (3B) and (3C) are mounted on the rotor (3) distributed in rows around it, where each row has the three types of fingers.

6. A process for removing mucilage adhered to fermented coffee comprising:
Addition of fermented coffee covered with mucilage to the hopper (8) together with a flow of water from the electric pump (14),
Reception of the flow of water and fermented coffee through the inlet frame (4),
Dosed entry of the flow of water and fermented coffee to the circular basket (2) through the movement of the rotor inlet auger (3) located horizontally,
Elimination of the mucilage adhered to the coffee as a result of the direct contact of the fermented coffee with the metal fingers (3A), (3B) and (3C) welded to the central body of the rotor (3), where said fingers rotate together with the rotor (3) and work as a team, so that (3A) agitates and rubs the beans, (3B) injects and atomizes the water at high pressure, and (3C) cleans the internal part of the circular basket (2),
Ejection of clean coffee by action of the rotor outlet auger (3) and water from the electric pump (14) through the outlet frame (5) and the outlet mouth (9) which is inclined.

7. A process for removing mucilage adhered to fermented coffee of claim 6, further comprising the steps:
Ejection of the mucilage and contaminants removed from the fermented coffee beans by the action of the rotor (3), the stirring fingers (3A) and the pressurized water injected by the fingers (3B), which are expelled from the system by the action of the cleaning fingers (3C) through the circular basket (2) which is constructed of square, round, or perforated sheet rods,
Storage of mucilage and contaminants in the mucilage tank (11).

8. A process for removing mucilage adhered to fermented coffee of claims 6 and 7, wherein the ejection step of the clean coffee is given by the action of the rotor outlet auger (3) through the outlet frame (5) and the outlet mouth (9) that are arranged downwards.
